(19) United States
(12) Patent Application Publication
(10) Pub. No.: US 2017/0029247 A1
(43) Pub. Date: Feb. 2, 2017

(54) ELEVATOR WITH A BRAKING DEVICE

(71) Applicant: ThyssenKrupp Elevator AG, Essen (DE)

(72) Inventors: Thomas Kuczera, Leinfelden-Echterdingen (DE); Walter Hoffmann, Niedernhausen (DE); Markus Hänle, Erkenbrechtsweiler (DE); Eduard Steinhauer, Nürtingen (DE)

(73) Assignee: ThyssenKrupp Elevator AG, Essen (DE)

(21) Appl. No.: 15/301,312

(22) PCT Filed: Mar. 27, 2015
(86) PCT No.: PCT/EP2015/056796

§ 371 Date: Sep. 30, 2016

(30) Foreign Application Priority Data
Apr. 3, 2014 (DE) 10 2014 206 461.9

(51) Int. Cl. B66B 5/18; B66B 1/32; B66B 1/36

(52) U.S. Cl. CPC B66B 5/18; B66B 1/365; B66B 1/32; B66B 9/00

(57) ABSTRACT

An elevator may include a brake apparatus such as a safety apparatus or a service brake, for example. The brake apparatus may be designed to generate a stepped braking force for braking an elevator car of the elevator. A plurality of brake cylinder assemblies may be configured so as to supply different braking forces. The brake cylinder assemblies may in some cases include a piston, a spring, and a brake pad. Moreover, a valve assembly may be utilized by one or more of the brake cylinder assemblies. Additional features of the brake apparatus may involve a compressor, a pressure accumulator, a pressure regulating valve.

The present invention relates to an elevator having a brake apparatus, in particular a safety apparatus or a service brake.

### PRIOR ART

In the case of elevators, there is an imperative need for safety apparatuses and service brakes which, in the event of overspeeding or uncontrolled traveling movements, decelerate the elevator car of the elevator safely to a standstill, and which hold the elevator car while it is at a standstill.

Safety apparatuses and service brakes generally do not offer the possibility of adjustment of the braking force. That is to say, they generate a constant braking force. Depending on the load state of the elevator car, the passengers are then subjected to different levels of deceleration during a braking process. In particular in the case of a low load, it is then the case, for example, that the passengers are subjected to very high levels of deceleration, whereby, for example, the traveling comfort may be reduced or the risk of an accident may be increased.

EP 0650703 A1 has disclosed an elevator having a brake, the brake force of which can be regulated. However, said brake has a complex construction, which is for example considered to be relatively maintenance-intensive.

There is therefore a demand for an elevator having a brake apparatus which provides a suitable braking force in accordance with the respective situation but which is characterized by a simple construction.

### DISCLOSURE OF THE INVENTION

The invention proposes an elevator having a brake apparatus, and a brake apparatus of said type. The subclaims and the following description relate to advantageous refinements.

The elevator according to the invention has a brake apparatus, in particular a safety apparatus or a service brake, wherein the brake apparatus is designed to generate a stepped braking force for braking an elevator car of the elevator.

### ADVANTAGES OF THE INVENTION

The invention is based on the realization that it is sufficient for the braking force to be provided in stepped fashion in a number of discrete braking steps. Accordingly, for example in the event of an emergency stop, the passengers in the cabin are not subjected to excessive deceleration, regardless of the state of load of the elevator car. A brake apparatus of said type has a considerably simpler construction than a brake that is adjustable in continuously variable fashion.

In one advantageous refinement of the invention, the brake apparatus has a multiplicity of individually actuable brake cylinder assemblies. It is advantageously the case that two to five brake cylinder assemblies are provided. If all of the brake cylinder assemblies are actuated at the same time, a maximum braking force value is provided. By contrast, if only some of the brake cylinder assemblies are actuated, a corresponding partial braking force value is provided. It is thus possible to provide a brake apparatus which has a particularly simple construction.

In an advantageous refinement of the invention, the brake cylinder assemblies are designed to each generate a substantially identical braking force value. In this case, a substantially identical braking force value is to be understood to mean a braking force value which fluctuates for example within manufacturing-induced component tolerances, for example by 5%, 10% or 20%. Accordingly, the brake apparatus can be formed from structurally identical brake cylinder assemblies, which simplifies manufacture and maintenance.

In one advantageous refinement of the invention, the brake cylinder assemblies are designed to generate different braking force values. In this way, through the selection of individual brake cylinder assemblies, it is possible to realize precise metering of the braking force, in particular of two to five, for example three brake cylinder assemblies.

In one advantageous refinement of the invention, the brake apparatus has at least one first brake cylinder assembly and one second brake cylinder assembly. The first brake cylinder assembly is designed to generate a first braking force value and the second brake cylinder assembly is designed to generate a second braking force value. In this case, the second braking force value is greater than the first braking force value, in particular is substantially twice as great as the first braking force value. A braking force which is substantially twice as great is in this case to be understood to mean a braking force value which fluctuates for example within manufacturing-induced component tolerances, for example by 5%, 10% or 20%. Thus, different braking force values can be provided by actuation of one brake cylinder assembly and actuation of the other brake cylinder assembly, such that a braking force can be provided in multiple braking force steps.

In an advantageous refinement of the invention, the brake apparatus has at least one further brake cylinder assembly. The further brake cylinder assembly is designed to generate a further braking force value. In this case, the further braking force value is three to five times, in particular substantially four times, as great as the first braking force value. A braking force value which is substantially four times as great is in this case to be understood to mean a braking force value which fluctuates for example within manufacturing-induced component tolerances, for example by 5%, 10% or 20%. Thus, an even greater number of different braking force values can be provided by actuation of a further brake cylinder assembly, such that the number of braking force steps can be further increased.

In one advantageous refinement of the invention, each brake cylinder assembly is assigned at least in each case one valve for the actuation of the brake cylinder assembly. If, in the event of a fault, a valve for the actuation of one brake cylinder assembly becomes non-functional, it is possible for at least other brake cylinder assemblies to be actuated by way of their respective valves, and thus a partial braking force can be provided. Operational safety is thus increased.

In one advantageous refinement of the invention, the brake apparatus has two brake units, of which a first brake unit is assigned to a first guide rail of the elevator and a second brake unit is assigned to a second guide rail of the elevator, wherein each brake unit has in each case one brake cylinder assembly, wherein a brake cylinder assembly of the first brake unit and a brake cylinder assembly of the second brake unit are assigned to in each case one valve assembly for the actuation of the brake units. Thus, owing to the actuation of the two braking units by way of one valve assembly, a symmetrical deceleration of the elevator car at both guide rails is attained.

In one advantageous refinement of the invention, the two brake units have the same number of brake cylinder assemblies. It is thus possible for the two brake units to be of structurally identical form, which simplifies manufacture and maintenance.

Further advantages and refinements of the invention will emerge from the description and from the appended drawing.

It is self-evident that the features mentioned above and the features yet to be discussed below may be used not only in the respectively specified combination but also in other combinations or individually without departing from the scope of the present invention.

The invention is schematically illustrated on the basis of an exemplary embodiment in the drawing, and will be described in detail below with reference to the drawing.

### DESCRIPTION OF THE FIGURES

FIG. 1 schematically shows a preferred embodiment of an elevator according to the invention having a brake apparatus, in a schematic illustration.

FIG. 2 schematically shows a section through a preferred embodiment of a brake apparatus as per FIG. 1 which can be used in accordance with the invention.

FIG. 3 schematically shows a circuit configuration of brake cylinder assemblies with valves, as per a first exemplary embodiment.

FIG. 4 schematically shows a circuit configuration of brake cylinder assemblies with valves, as per a second exemplary embodiment.

FIG. 5 schematically shows a further alternative circuit configuration.

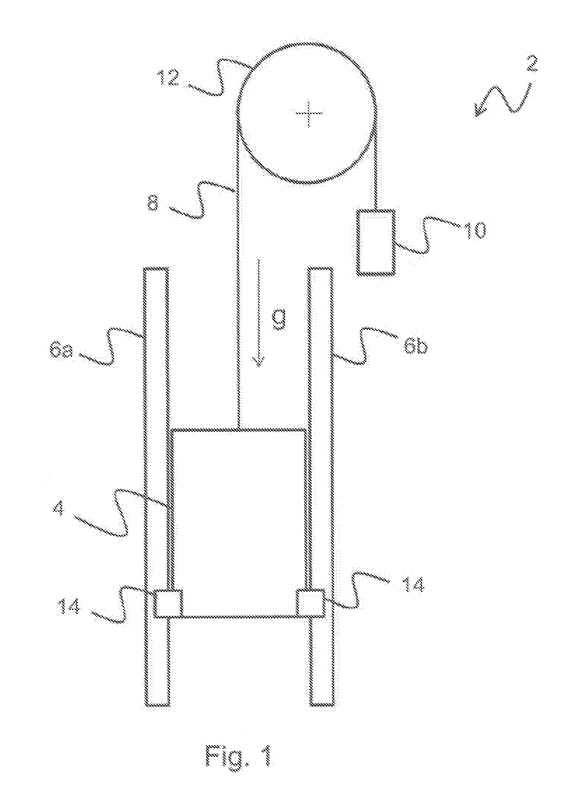

FIG. 1 schematically illustrates an elevator 2 as a preferred refinement of an elevator system according to the invention.

In the present exemplary embodiment, the elevator 2 has an elevator car 4 for the transportation of passengers and/or loads, which elevator car is mounted on two guide rails 6a, 6b, which run parallel to one another, in an elevator shaft such that said elevator car can travel in or counter to the direction of gravitational force g. By contrast to the present exemplary embodiment, it is however for example also possible for the elevator car 4 to be mounted, such that it can travel, on a single guide rail.

For the travel of the elevator car 4, a drive is provided which, in the present exemplary embodiment, is in the form of a driving-pulley drive. In this case, the elevator car 4 may have a cabin and a safety frame (neither of which are illustrated). In the present exemplary embodiment, the drive has a supporting cable 8 which is fastened to the top side of the elevator car 4. The supporting cable 8 runs on a driving pulley 12 which can be motor-driven by means of a motor (not illustrated) in order to cause the elevator car 4 to travel. In the present exemplary embodiment, a counterweight 10 is fastened to the other end, which is situated opposite the elevator car 4, which counterweight 10, by weight balancing, reduces the force expenditure required for causing the elevator car 4 to travel. By contrast to the present exemplary embodiment, the elevator may be designed as an elevator without supporting means. An elevator without supporting means is an elevator system which does not use cables or belts which are driven by means of a driving pulley 12. The drive of such elevators is situated directly on the elevator car 4. Here, use is made, for example, of toothed-rack drives and linear drives.

To brake the elevator car 4 to a standstill, for example if overspeeding and/or uncontrolled traveling movements of the elevator car 4 occur, a brake apparatus 14 is provided, which in the present exemplary embodiment is in the form of a safety apparatus and/or service brake.

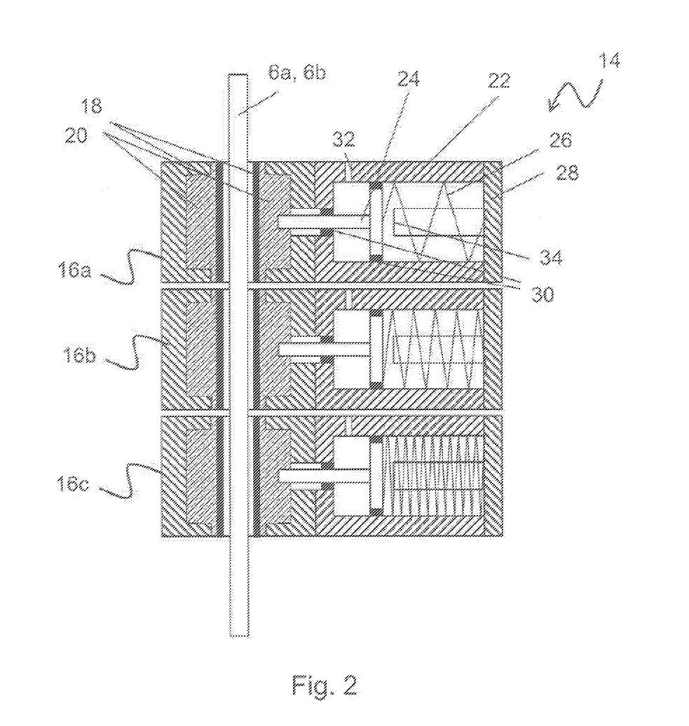

FIG. 2 shows the brake apparatus 14 in detail.

In the present exemplary embodiment, the brake apparatus 14 comprises in each case three brake cylinder assemblies 16a, 16b, 16c, which are arranged to both sides of the elevator car 4. By contrast to the present exemplary embodiment, it is however also possible for the brake apparatus 14 to have only two, or more than three, for example four or five, brake cylinder assemblies. The brake cylinder assemblies 16a, 16b, 16c interact with the guide rail 6a or 6b in order to brake the elevator car 4. For this purpose, each brake cylinder assembly 16a, 16b, 16c has, to both sides, in each case one brake pad 18 which, in the present exemplary embodiment, is of flat, that is to say substantially cuboidal form. The brake pads 18 are inserted into a respective brake pad holder 20 of each of the brake cylinder assemblies 16a, 16b, 16c. The brake cylinder assemblies 16a, 16b, 16c are mounted in floating fashion, that is to say the brake cylinder assemblies 16a, 16b, 16c are mounted so as to be horizontally displaceable in order to ensure uniform abutment of the brake pads 18.

Each brake cylinder assembly 16a, 16b, 16c has a cylinder 22 in which a piston 24 is mounted in displaceable fashion, wherein the piston 24 is operatively connected to the brake pads 18 in order to place the latter in contact with the guide rails 6a, 6b when the elevator car 4 is to be braked. The piston 24 is furthermore subjected to spring preload by means of a spring 26, which in the present exemplary embodiment is in the form of a compression spring, wherein the spring 26 generates the contact pressure for placing the brake pads in contact with the guide rails 6a, 6b. In this case, a cover 28 closes off the cylinder 22, which is open on one side. Seals 30 are provided for sealing off the piston 24. Finally, each brake cylinder assembly 16a, 16b, 16c has a respective pressure medium port 32 for the ventilation of the brake apparatus 14.

In the present exemplary embodiment, the brake cylinder assemblies 16a, 16b, 16c are designed to generate different braking forces. In the present exemplary embodiment, the first brake cylinder assembly 16a is designed to generate a braking force value of 5 kN, the second brake cylinder assembly 16b is designed to generate a braking force value of 10 kN, and the third brake cylinder assembly 16c is designed to generate a braking force value of 20 kN. By contrast to the present exemplary embodiment, the braking force values may also be staggered differently.

Thus, the third brake cylinder assembly 16c generates a braking force value which is twice as great as the braking force value generated by the second brake cylinder assembly 16b. Furthermore, the second brake cylinder assembly 16b generates a braking force value which is four times as great as the braking force value generated by the first brake cylinder assembly 16a.

Thus, through individual actuation of selected brake cylinder assemblies 16a, 16b, 16c, it is possible for braking forces with values of 5 kN, 10 kN, 15 kN, 20 kN, 25 kN, 30 kN and 35 kN to be generated. The brake apparatus thus has seven braking force steps, and generates a stepped braking force with seven steps.

To generate the different braking forces, it is provided in the present exemplary embodiment that the springs 26 of the brake cylinder assemblies 16a, 16b, 16c are of different strength. If all of the brake cylinder assemblies 16a, 16b, 16c are charged with the same operating pressure, for example of the hydraulic oil, different spring forces act in each of the brake cylinder assemblies 16a, 16b, 16c, which spring forces lead to different deflections of the pistons 24 in each case.

In the present exemplary embodiment, a stop 34 is provided in each cylinder 22, which stop delimits a displacement travel of the piston 24. Instead of the stop 34, it would be possible for the base surface area of the pistons 24 of the brake cylinder assemblies 16a, 16b, 16c to be varied, or the brake cylinder assemblies 16a, 16b, 16c are charged with in each case different operating pressures in order to generate different braking forces.

By contrast to this, it is however possible for the brake cylinder assemblies 16a, 16b, 16c to be designed to generate identical braking forces.

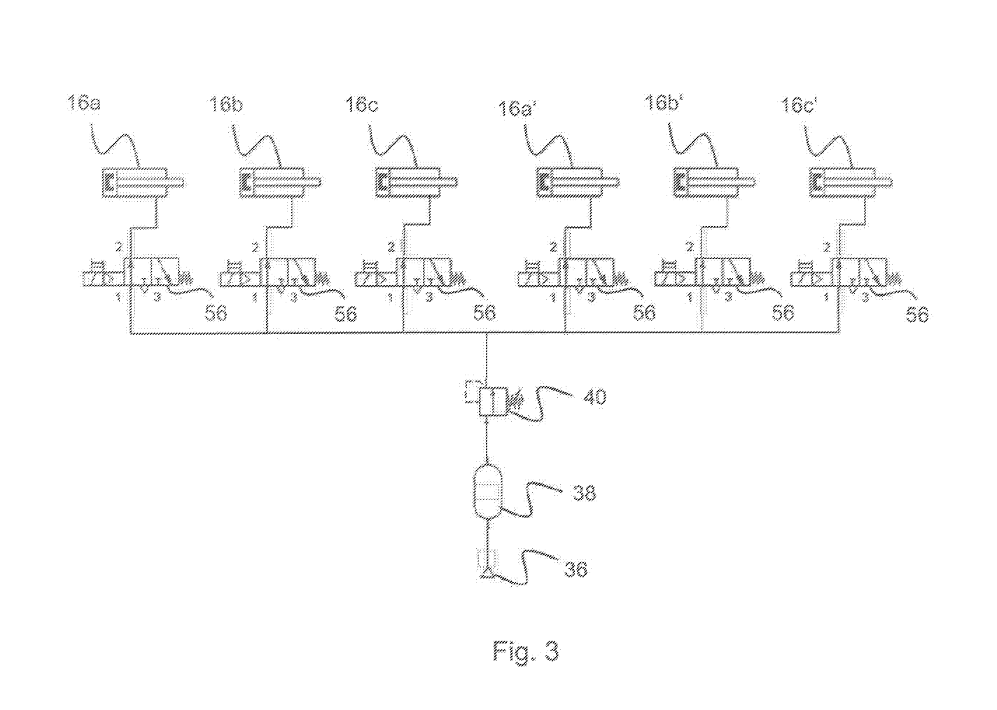

FIG. 3 shows an exemplary embodiment of the brake apparatus 14 in which in each case three brake cylinder assemblies 16a, 16b, 16c, 16a′, 16b′, 16c′ are provided for both sides of the elevator car 4.

In each case one valve 56 is assigned to a respective one of the brake cylinder assemblies 16a, 16b, 16c; 16a′, 16b′, 16c′.

For the supply of pressure to the brake apparatus 14, a motor-driven compressor 36 is provided in the present exemplary embodiment. Between the compressor 36 and the valves 56 there is provided a pressure accumulator 38 which provides a pressure higher than the minimum operating pressure of the brake apparatus 14. At the same time, the pressure accumulator 38 serves as a buffer, for example in the event of an electrical failure. The pressure accumulator 38 then provides a reserve with which the elevator car 4 can be released from the arresting action by a triggered brake apparatus 14, for example in order that said elevator car can be caused to travel to a nearest stopping point of the elevator 2 for the purposes of passenger evacuation. Furthermore, the pressure accumulator 38 serves as a reserve in the event of, for example, frequent switching cycles, such that a smaller compressor 36 can be used than in the case of a design without a pressure accumulator 38.

Furthermore, in the present exemplary embodiment, a pressure limiting valve or pressure regulating valve 40 is provided between the valves 56 and the pressure accumulator 38, as a pressure prevailing in the pressure accumulator 38 may be higher than that required for the restoring movements of the brake cylinder assemblies 16a, 16b, 16c; 16a′, 16b′, 16c′ counter to the spring 26. In the present exemplary embodiment, the valves 56 themselves are in the form of 3/2 directional valves.

By contrast to the illustration in FIG. 3, it is possible for in each case two valves 56 connected in parallel to be provided for each of the brake cylinder assemblies 16a, 16b, 16c, 16a′, 16b′, 16c′ in order to provide redundancy.

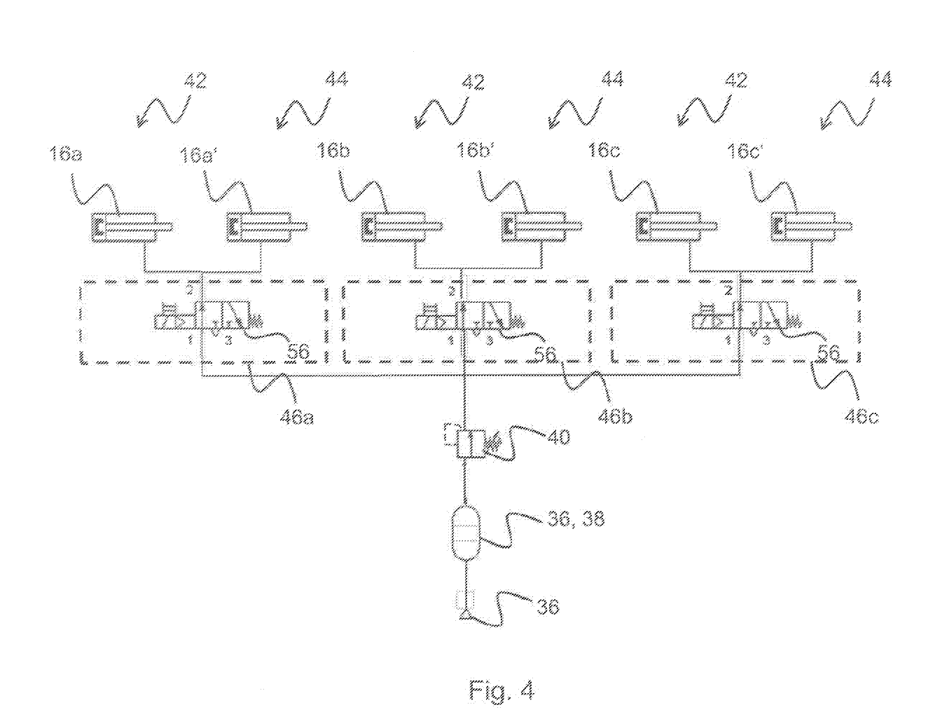

The exemplary embodiment shown in FIG. 4 differs from the exemplary embodiment shown in FIG. 3 in that the brake apparatus 14 has two brake units 42, 44. The first brake unit 42 is assigned to the first guide rail 6a of the elevator 2 and the second brake unit 44 is assigned to the second guide rail 6b of the elevator 2. In the present exemplary embodiment, each brake unit 42, 44 has in each case three brake cylinder assemblies 16a, 16b, 16c and 16a′, 16b′, 16c′ respectively. In this case, the brake cylinder assembly 16a of the first brake unit 42 and the brake cylinder assembly 16a′ of the second brake unit 44 are assigned to a valve assembly 46a with one of the valves 56. Furthermore, the brake cylinder assembly 16b of the first brake unit 42 and the brake cylinder assembly 16b′ of the second brake unit 44 are assigned to a second valve assembly 46b with one of the valves 56. Finally, the brake cylinder assembly 16c of the first brake unit 42 and the brake cylinder assembly 16c′ of the second brake unit 44 are assigned to a third valve assembly 46c with one of the valves 56. Thus, in the present exemplary embodiment, the two brake units 42, 44 have the same number of brake cylinder assemblies 16a, 16b, 16c and 16a′, 16b′, 16c′ respectively.

Furthermore, in each case two brake cylinder assemblies 16a, 16b, 16c and 16a′, 16b′, 16c′ respectively are assigned in each case one valve 56. Thus, through the actuation of the respective valves 56, a braking force of equal magnitude is effected at both guide rails 6a and 6b, which yields a symmetrical deceleration of the elevator car 4 on both sides in a simple manner.

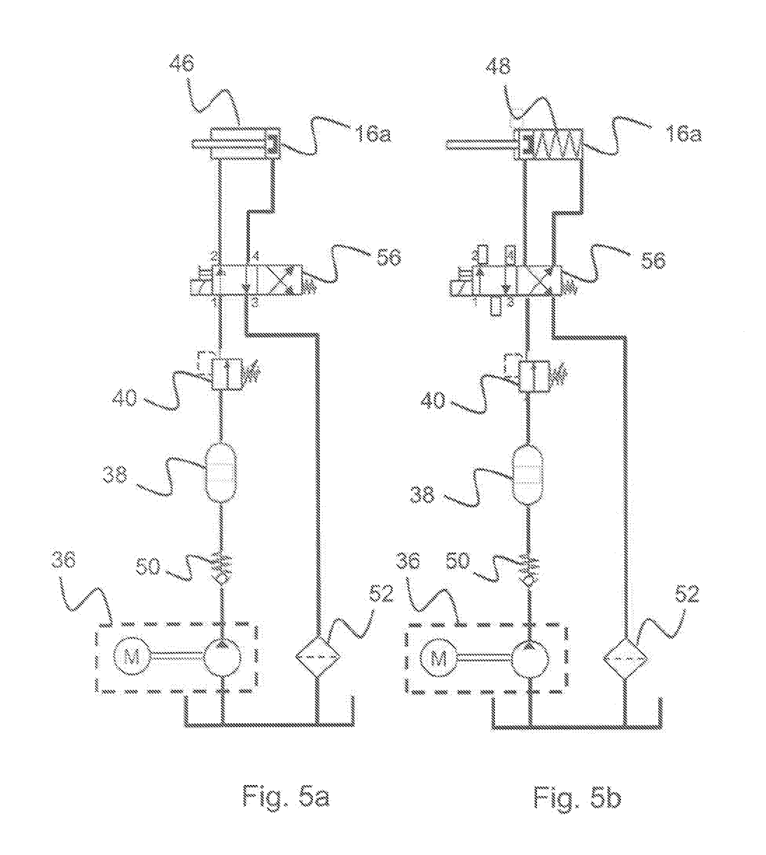

By contrast to the illustration in the figure, it may be provided that each valve assembly 46a, 46b, 46c has in each case two valves 56 connected in parallel in order to provide redundancy. FIGS. 5a and 5b show, by way of example on the basis of the brake cylinder assembly 16a, a further exemplary embodiment in which the valves 56 are in the form of 4/2 directional valves. Furthermore, in this exemplary embodiment, the brake cylinder assembly 16a is of double-acting design. Thus, when the brake apparatus 14 is open, a first chamber 48 of the brake cylinder assembly 16a is charged with a pressure medium, such as for example hydraulic oil, whereas when the brake apparatus 14 is closed, a second chamber 50 of the brake cylinder assembly 16a is charged with the pressure medium. Thus, in addition to the spring force of the spring 26, the pressure medium acts on the piston 24 in order to displace the latter. Furthermore, in the exemplary embodiment as per FIG. 5, a check valve 52 and a collecting vessel 54 are provided.

During operation, a controller (not illustrated) measures the present acceleration and speed of the elevator car 4 and evaluates these with regard to whether limit values are overshot. The controller switches the brake cylinder assemblies 16a, 16b, 16c and 16a′, 16b′, 16c′ in a manner dependent on the load state of the elevator car 4. Furthermore, for reliable control, an emergency power generator or battery is provided in order that, in the event of an electrical failure, a situation is prevented in which all of the brake cylinder assemblies 16a, 16b, 16c and 16a′, 16b′, 16c′ abruptly engage and effect an excessive deceleration of the elevator car 4.

The valves 56 are furthermore switched such that the safe state of the valves 56 in the event of an electrical failure causes the brake apparatus 14 to be engaged (activated).

### LIST OF REFERENCE SIGNS

2 Elevator

4 Elevator car

6a Guide rail

6b Guide rail

8 Supporting cable

10 Counterweight

12 Drive pulley

14 Brake apparatus

16a Brake cylinder assembly

16a′ Brake cylinder assembly

16b Brake cylinder assembly

16b′ Brake cylinder assembly

16c Brake cylinder assembly

16c′ Brake cylinder assembly

18 Brake pad

20 Brake pad holder

22 Cylinder

24 Piston

26 Spring

28 Cover

30 Seal

32 Pressure medium port

34 Stop

36 Compressor

38 Pressure accumulator

40 Pressure limiting or pressure regulating valve

42 Brake unit

44 Brake unit

46a Valve assembly

46b Valve assembly

46c Valve assembly

48 First chamber

50 Second chamber

52 Check valve

54 Collecting tank

56 Valve

g Direction of gravitational force

1-8. (canceled)

9. An elevator comprising a brake apparatus that generates a stepped braking force for braking an elevator car, the brake apparatus comprising a plurality of individually-actuatable brake cylinder assemblies, wherein each individually-actuatable brake cylinder assembly generates a different braking force.

10. The elevator of claim 9 wherein the plurality of individually-actuatable brake cylinder assemblies of the brake apparatus comprises a first brake cylinder assembly and a second brake cylinder assembly, wherein a braking force generated by the second brake cylinder assembly is at least twice as strong as a braking force generated by the first brake cylinder assembly.

11. The elevator of claim 10 wherein the plurality of individually-actuatable brake cylinder assemblies of the brake apparatus comprises a third brake cylinder assembly, wherein a braking force generated by the third brake cylinder assembly is between three and five times as strong as the braking force generated by the first brake cylinder assembly.

12. The elevator of claim 9 each of the plurality of individually-actuatable brake cylinder assemblies comprises a valve for actuation of the respective individually-actuatable brake cylinder assembly.

13. The elevator of claim 9 wherein the brake apparatus comprises a first brake unit assigned to a first guide rail and a second brake unit assigned to a second guide rail, wherein each of the first and second brake units comprises one of the plurality of individually-actuatable brake cylinder assemblies, wherein the brake cylinder assembly of the first brake unit and the brake cylinder assembly of the second brake unit are assigned in each case to a valve assembly for the actuation of the first and second brake units.

14. The elevator of claim 13 wherein the first and second brake units include a same number of brake cylinder assemblies.

15. The elevator of claim 9 further comprising a controller for selecting and switching the plurality of individually-actuatable brake cylinder assemblies in a manner dependent on a load state of the elevator car.

16. A brake apparatus for a safety apparatus or a service brake of an elevator, wherein the brake apparatus is configured to generate a stepped braking force for braking an elevator car of the elevator.

17. The brake apparatus of claim 16 further comprising a controller for selecting and switching a plurality of individually-actuatable brake cylinder assemblies in a manner dependent on a load state of the elevator car.

18. A brake apparatus for an elevator, the brake apparatus comprising:
a plurality of brake cylinder assemblies each of which is individually actuatable, wherein the plurality of brake cylinder assemblies are configured to generate a stepped braking force for braking an elevator car, wherein at least two of the plurality of brake cylinder assemblies generate different braking forces; and
a plurality of valves for the actuation of the plurality of brake cylinder assemblies.

19. The brake apparatus of claim 18 wherein at least two of the plurality of brake cylinder assemblies utilize one of the plurality of valves.

20. The brake apparatus of claim 18 further comprising a compressor for supplying pressure to the plurality of brake cylinder assemblies.

21. The brake apparatus of claim 18 further comprising a pressure accumulator that provides a pressure higher than a minimum operating pressure of the brake apparatus, wherein the pressure accumulator acts as a buffer in case of an electrical failure that provides a reserve with which an elevator car can be released from an arresting action by a triggered brake apparatus.

22. The brake apparatus of claim 21 further comprising a pressure regulating valve disposed between the pressure accumulator and at least one of the plurality of valves.

23. The brake apparatus of claim 18 wherein at least one of the plurality of valves is a 4/2 directional valve.

24. The brake apparatus of claim 18 wherein at least one of the plurality of valves is a 3/2 directional valve.

25. The brake apparatus of claim 18 wherein each of the plurality of brake cylinder assemblies comprises a piston, a spring, and a brake pad, wherein the springs of at least two of the plurality of brake cylinder assemblies are of different types.

26. The brake apparatus of claim 18 wherein the at least one of the plurality of brake cylinder assemblies is a double-acting design.

27. The brake apparatus of claim 26 further comprising first and second chambers that can be charged with a pressure medium.
